(19) United States
(12) Patent Application Publication
(10) Pub. No.: US 2015/0170355 A1
(43) Pub. Date: Jun. 18, 2015

(54) WAFER APPEARANCE INSPECTION SYSTEM AND METHOD OF SENSITIVITY THRESHOLD SETTING

(71) Applicant: HITACHI HIGH-TECHNOLOGIES CORPORATION, Tokyo (JP)

(72) Inventor: Mitsuhiro Yoshida, Tokyo (JP)

(21) Appl. No.: 14/415,545

(22) PCT Filed: Jul. 2, 2013
(86) PCT No.: PCT/JP2013/068168

§ 371 Date: Jan. 16, 2015

(30) Foreign Application Priority Data
Jul. 20, 2012 (JP) 2012-161949

(51) Int. Cl. G06T 7/00

(52) U.S. Cl. CPC G06T 7/0004; G06T 2207/10004; G06T 2207/30148

(57) ABSTRACT

A wafer appearance inspection system subdivides the area of an inspection object, easily executing a work for setting the sensitivity threshold at each area, improving the efficiency of the inspection. In the image area displayed on the display, when the area is roughly designated in order to set a threshold value, the area is automatically decided. The area having a pattern similar to a pattern of the decided area is searched and displayed. When the similarity area is selected, the initial sensitivity threshold value is displayed. If the changing operation is required, the changing operation is executed. The sensitivity threshold value is set by the color corresponding to the decided threshold value, and the area having the threshold value is displayed. The inspection is executed in accordance with the set threshold value.

### TECHNICAL FIELD

The present invention relates to a wafer appearance inspection system for inspecting a defect in the surface of a wafer on a semiconductor manufacturing process.

### BACKGROUND ART

A wafer appearance inspection system is used in the semiconductor manufacturing process. The making operation of a recipe is required to be made in order to inspect a wafer by the wafer appearance inspection system automatically. A worker is required to make one part of the recipe.

There is a work for changing a sensitivity threshold to be detected in accordance with a position on the wafer and the position of the inspection area in a die. It is one work required by a worker. This is the reason that a high contrast area and low contrast area are mixed in the wafer, and the inspection accuracy can be improved by setting a sensitivity threshold at each area respectively.

Accordingly, it is required as needs that the inspection areas in a die are finely divided and a sensitivity threshold is set at each of the finely divided areas respectively. There is a technique (for example, the patent document 1) for setting inspection areas in a die with reference to a displayed panorama image (displayed image made of plural images composed of images selected from obtained images) of the die on the background of the image for setting the inspection area in the die.

Further, there are known method for dividing the area on the basis of the SEM image to apply the inspection, and known method for matching the SEM image or optical image with a template image to inspect the wafer.

### PRIOR ART DOCUMENTS

### Patent Document

Patent Document 1: JP2010-283088A

### SUMMARY OF THE INVENTION

### Problem to be Solved by the Invention

However, according to the patent document 1, when thousands of inspection areas in a die are set, same operations are repeated at extravagant number of items.

According to a method for setting the inspection area in a die by a worker, the efficiency is very low and a human error may be occurred. However, a worker must be required to set numerous inspection areas in a die at each sensitivity threshold for keeping a high accuracy.

Therefore, in a prior art, numerous times and labors are required to subdivide the inspection object in order to improve the sensitivity, so that it as difficult to improve the efficiency of the inspection.

An object of the present invention is to realize a wafer appearance inspection system and a sensitivity threshold setting method capable for subdividing the area of an inspection object and for easily executing a work for setting the sensitivity threshold at each area and for improving the efficiency of the inspection.

### Means for Solving the Problems

For attaining the foregoing object, the present invention is configured as described below.

A light is irradiated to an wafer, the light reflected from the wafer being detected, the detected light being displayed on an image display section as an image, an image area commanded by an operation section for inputting an operation command being decided, an image area having a surface configuration similar to a surface configuration of the decided image area being searched and displayed on the image display section, a sensitivity threshold of the image area decided in accordance with the command from the operation section being set.

### Effects of the Invention

The present invention can realize a wafer appearance inspection system and a sensitivity threshold setting method capable for subdividing the area of an inspection object and for easily executing a work for setting the sensitivity threshold at each area and for improving the efficiency of the inspection.

### BRIEF DESCRIPTION OF DRAWINGS

FIG. 1 shows an example of the construction of a wafer appearance inspection system of an embodiment according to the present invention.

FIG. 2 shows an example of the construction of a review optical system in the wafer appearance inspection system.

FIG. 3 shows an example of a process flowchart of a process for setting sensitivity designation inspection area in a die in the wafer appearance inspection system.

FIG. 4 shows an example for displaying set inspection area in the die at the operation for setting the sensitivity designation inspection area in the die.

FIG. 5 shows an operation for searching a similar inspection area in the die.

FIG. 6 shows an operation for selecting the searched inspection area in the die.

FIG. 7A shows a method for setting a searching area at the operation for searching an inspection area in the similar die.

FIG. 7B shows a method for setting a searching area at the operation for searching an inspection area in the similar die.

FIG. 8 shows a function for automatically selecting an inspection area in the die along an image brightness edge at the operation for searching an inspection area in single die.

FIG. 9 shows a function for correcting the size of the inspection area to a size along the image brightness edge at the operation for selecting an inspection area in single die.

FIG. 10 shows a function for adjusting the inspection area in the set die along the image brightness edge.

FIG. 11 shows a function for adjusting a reduced scale of an image to be displayed in accordance with the contents of a next operation.

FIG. 12 shows a function for distributing colors to the inspection areas in the set die to be displayed based on the image information of the inspection area in the set die.

FIG. 13 shows a function for estimating the sensitivity threshold information based on the image information of the inspection area in the set die.

FIG. 14 shows one example of the operation screen.

FIG. 15 is a block diagram of internal functions of a CPU 120.

### MODE FOR CARRYING OUT THE INVENTION

The present invention will be described herein under with reference to the attached drawings.

### Embodiments

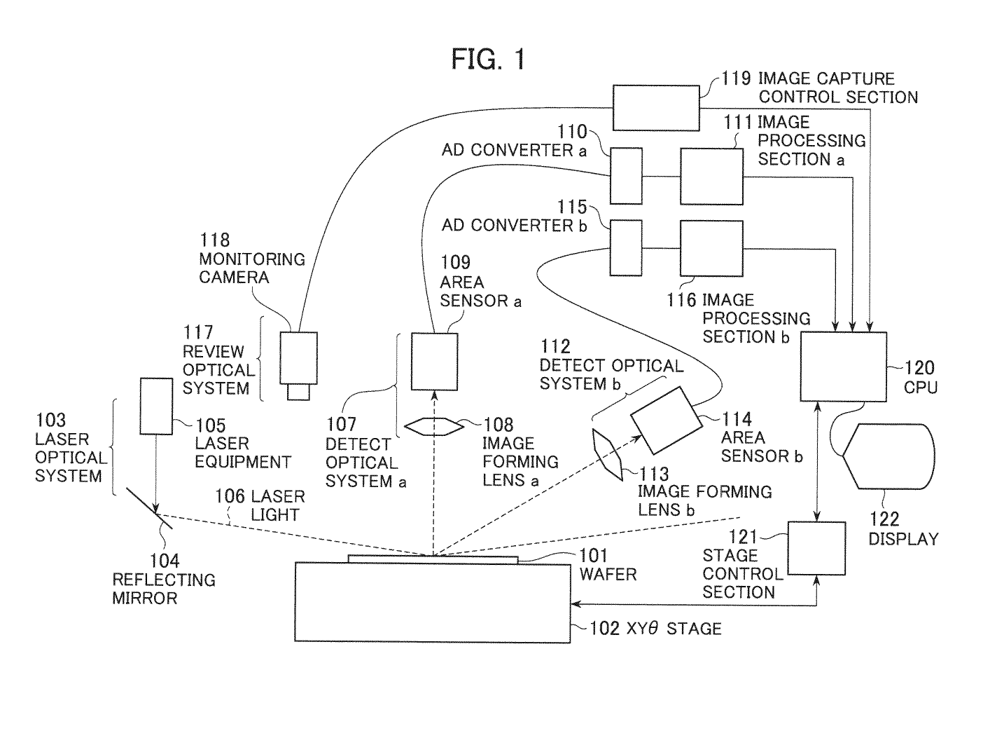

FIG. 1 is a whole schematic construction drawing of a wafer appearance inspection system of one embodiment according to the present invention.

In FIG. 1, a laser optical system 103 includes laser equipment 105 and a reflecting mirror 104. A laser light 106 is irradiated to an wafer 101 from the laser equipment 105 through the reflecting mirror 104. An XYθ stage 102 is operated by a stage control section 121 to inspect the whole surface of the wafer 101.

When a foreign body exists on the surface of the wafer 101 or when the surface of the wafer 101 is uneven, the laser light 106 is scattered. Further, the scattered light is detected by detect optical systems 107 and 112. The detection optical system 107 includes an image forming lens 108 and an area sensor 109, the detection optical system 112 including an image forming lens 113 and an area sensor 114.

The scattered light is converted into electrical signals by the detect optical systems 107 and 112, the electrical signals being transmitted as image data to a CPU 120, which is an operation control section, through AD converters 110, 115, image processing sections 111 and 116.

A review optical system 117 is used for making a recipe for inspection and the estimation of defect inspection (for review of the detected defect), being independent of detect optical systems 107 and 112. An image obtained by a monitoring camera 118 is processed by an image capture control section 119 and the CPU 120, being displayed on a monitoring display 122.

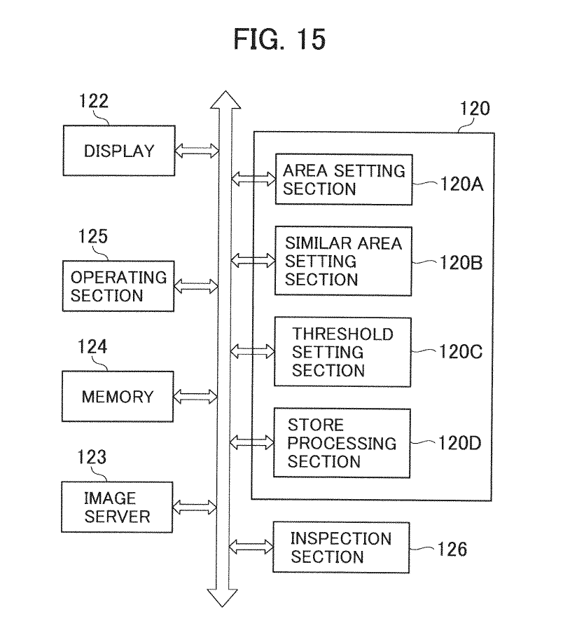

FIG. 15 is a block diagram of the internal functions of the CPU 120. In FIG. 15, the CPU 120 includes an area setting section 120A, a similar area setting section 120B, a threshold setting section 120C, and a store processing section 120D. The CPU 120 is connected to an operating section 125, a memory 124 for storing setting data, an image server 123, and an inspection section 126 for executing visual inspection of the wafer to be inspected, which are omitted in FIG. 1.

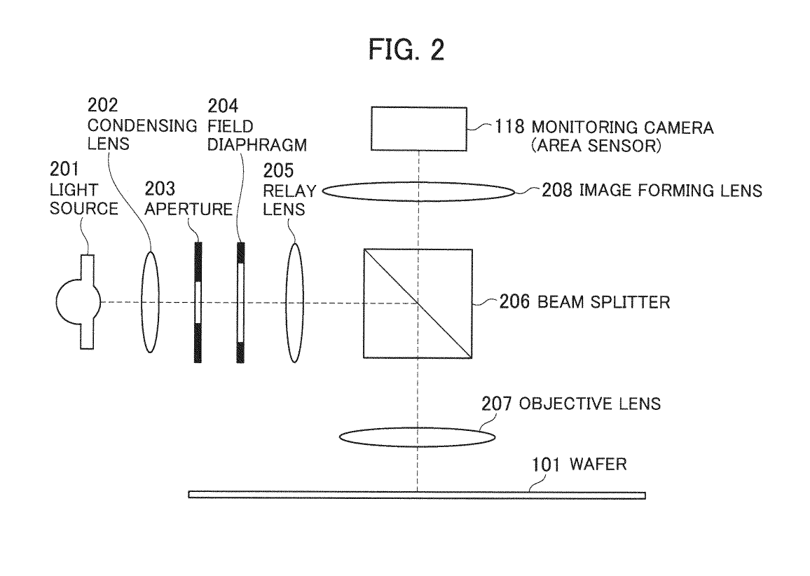

FIG. 2 shows an example of the schematic construction of the review optical system 117 in the wafer appearance inspection system. In FIG. 2, the light emitted from a light source 201 is collected by a condensing lens 202. The brightness of the light collected by the condensing lens 202 is adjusted by an aperture 203, the observation range of the light being adjusted by a field diaphragm 204.

Thereafter, the light is reflected by a beam splitter 206 through a relay lens 205, the wafer 101 being irradiated with the light through an objective lens 207. The light reflected from the wafer 101 permeates the beam splitter 206 through the objective lens 207. Finally, the light is converted into electrical signals by the monitoring camera 118 (area sensor) through an image forming lens 208.

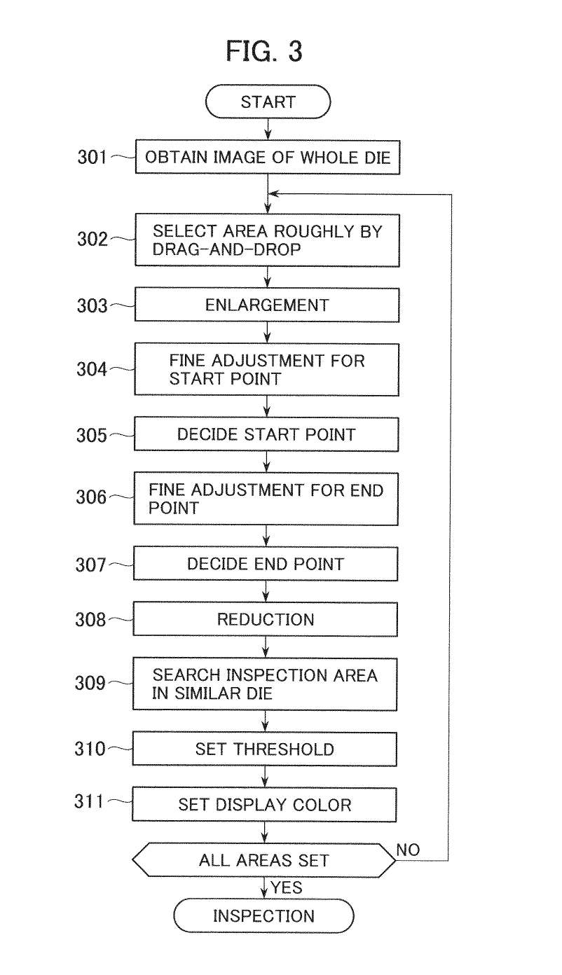

FIG. 3 shows an example of a process flowchart of a process for setting sensitivity designation inspection area in a die in the wafer appearance inspection system.

Firstly, the process in the step 301 for obtaining whole image of the die will be described with reference to FIG. 1.

The wafer 101 is loaded on the XYθ stage 102. Further, the alignment process is executed to correct the inclination of the wafer 101 on the XYθ stage 102. The XYθ stage 102 is being moved with the stepping movement in X direction and Y direction, the images of the wafer 101 being obtained by the monitoring camera 118 one by one, the obtained images being stored in the image server 123. All these works are automatically executed by the control of the CPU 120.

Next works are executed by using the obtained images stored in the sever 123, so that the next works can be processed by other PC capable for accessing the server 123.

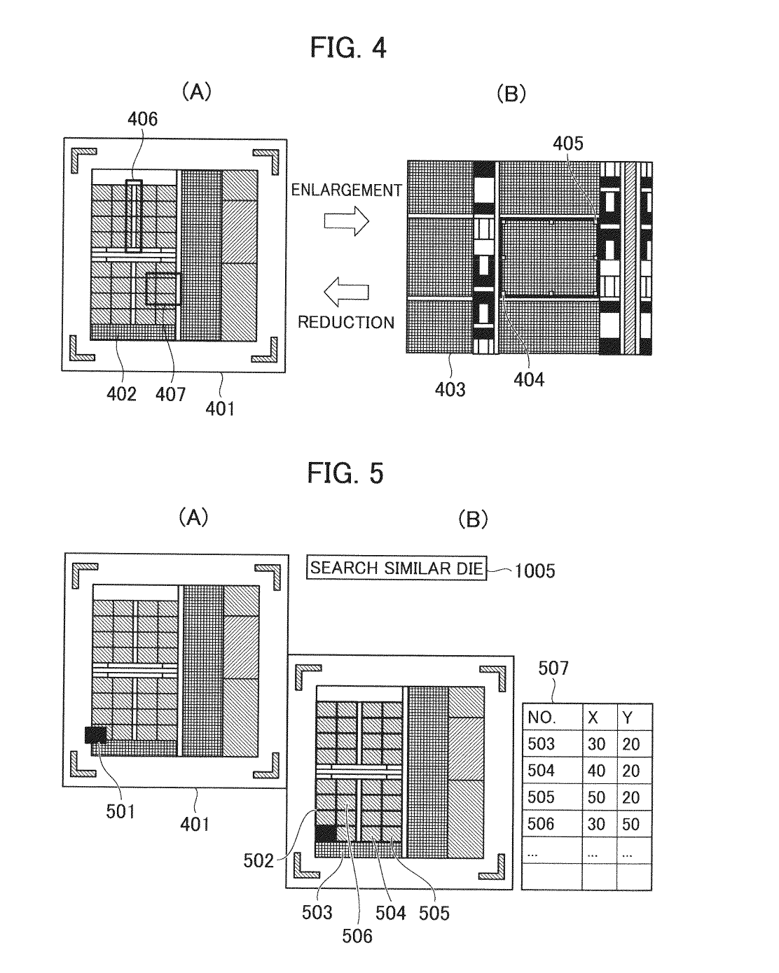

FIG. 4 shows an example for displaying set inspection area in the die at the operation for setting the sensitivity designation inspection area in the die. The area select step 302 in FIG. 3 will be explained with reference to the example. In (A) of FIG. 4, reference numeral 401 represents a schematic diagram of the panorama composition image of whole die, the panorama composition image being generally divided a cell area portion 402 and a logic portion 406.

The panorama composition image 401 of whole die is displayed on the display 122 or PC connected to the image server 123. Further, an area 407 in the die is selected roughly by using the drag and drop operation on the panorama composition image 401 (the step 302 in FIG. 3).

Next, the enlargement step 303, the fine adjustment step 304 to the decide end point step 307 in FIG. 3 will be explained with reference to FIG. 4.

When the area 407 in the die is enlarged on the display 122, the area 407 in the die is enlarged and displayed as the enlarged area 403 in (B) of FIG. 4 (the step 303 in FIG. 3). A start point handle 404 and an end point handle 405 are dragged and dropped to finely adjust a range to be selected (the steps 304 to 307 in FIG. 3).

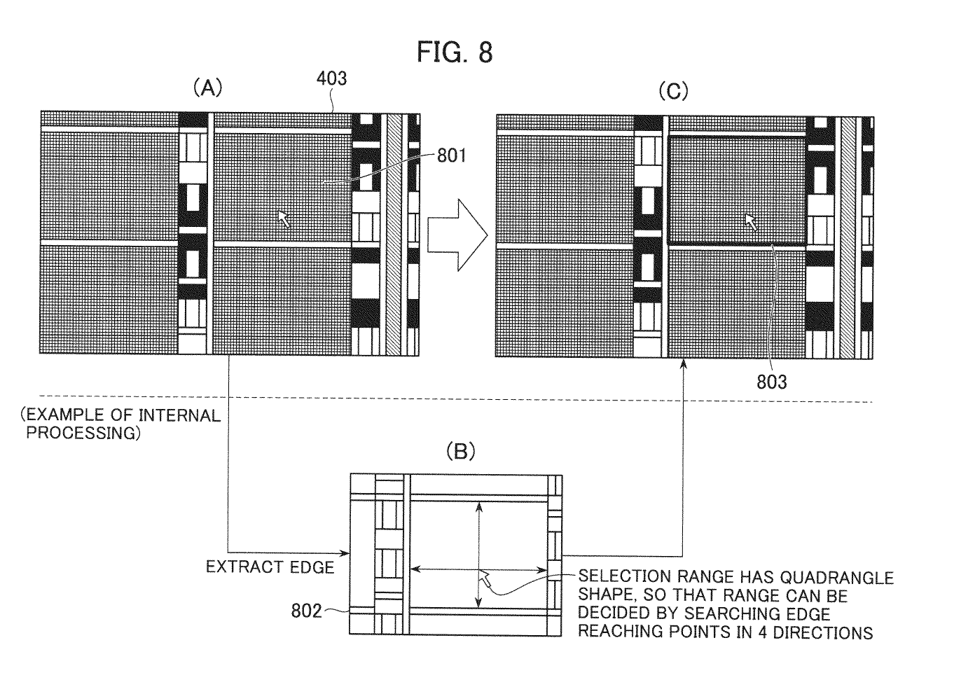

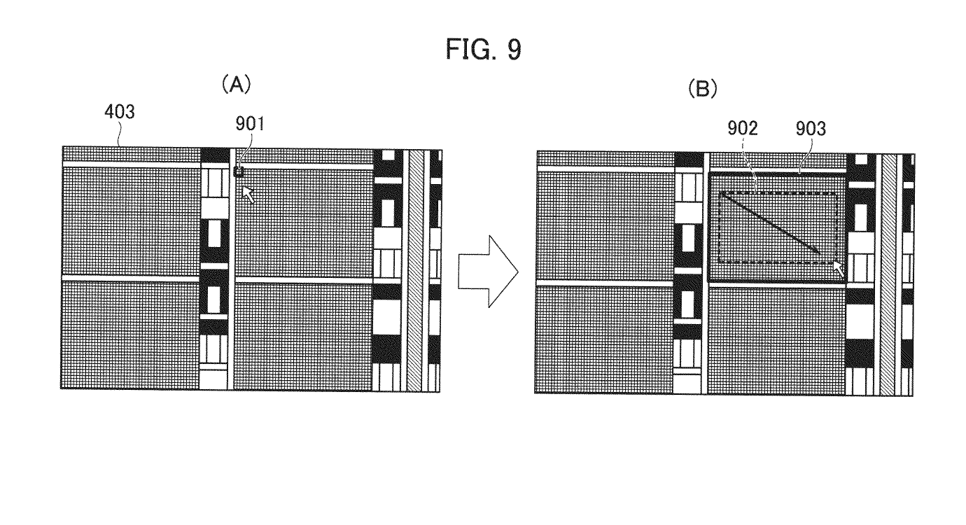

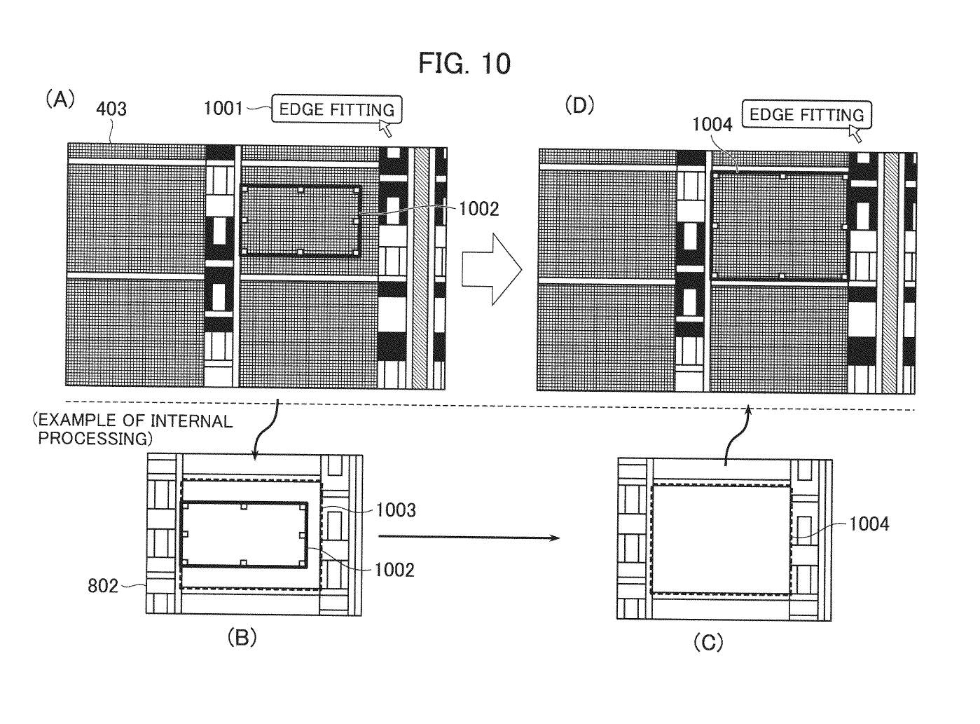

FIG. 8, FIG. 9, and FIG. 10 are drawings for explaining the functions automatically supporting the fine adjustment of the start point handle 404 and the endpoint handle 405 (corresponding to the steps 304 to 307 in FIG. 3).

FIG. 8 is a drawing for explaining a function for automatically selecting an inspection area along an image brightness edge by using the double click operation at the operation for searching an inspection area in some single die. Further, FIG. 9 is a drawing for explaining a function for automatically searching the area along the image brightness edge by using the drag-and-drop operation.

In (A) of FIG. 8, when an area is selected by using the double click operation, the double click operation is executed in the area 801 to be selected. As shown in (B) of FIG. 8, the image 802 is generated by extracting the edge of the image 802 by the image processing system of the CPU 120. An area is searched from the clicked point in four directions of up down and left right directions, a first reached edge is detected. By doing so, as shown in (C) of FIG. 8, a rectangle area 803 along the edge (black frame) can be selected.

As shown in FIG. 9, when the mouse pointer approaches to the corner 901 which is the nearest corner in an area to be selected, the corner 901 is highlighted in case that an inspection area is selected by the drag-and-drop operation ((A) of FIG. 9). Further, as shown in (C) of FIG. 9, when the drag-and-drop operation is executed, the area 903 is enclosed by the edge in the corners adjacent to the drag start point and drag end point, and the area 903 (the amended selection highlight) is set as a selected area. The area 902 is a selected area without amendment.

FIG. 10 is a drawing for explaining the function for adjusting the inspection area along the image brightness edge. A method for reducing the workload of the fine adjustment for the selected area (the steps 304 to 307 in FIG. 3) will be explained by using FIG. 10.

In (A) of FIG. 10, the edge fit button 1001 displayed on the screen is depressed in condition that an area 1002 is selected. As shown in (B) of FIG. 10, the image 802 (the edge of the image 802 is extracted by the image process system of the CPU 120) is generated, the edge 1003 adjacent to the four sides of the area 1002 being detected. Each of the detected edges is shaped to be rectangular ((C) of FIG. 10), so that it is decided to be a new selected area 1004 ((D) of FIG. 10).

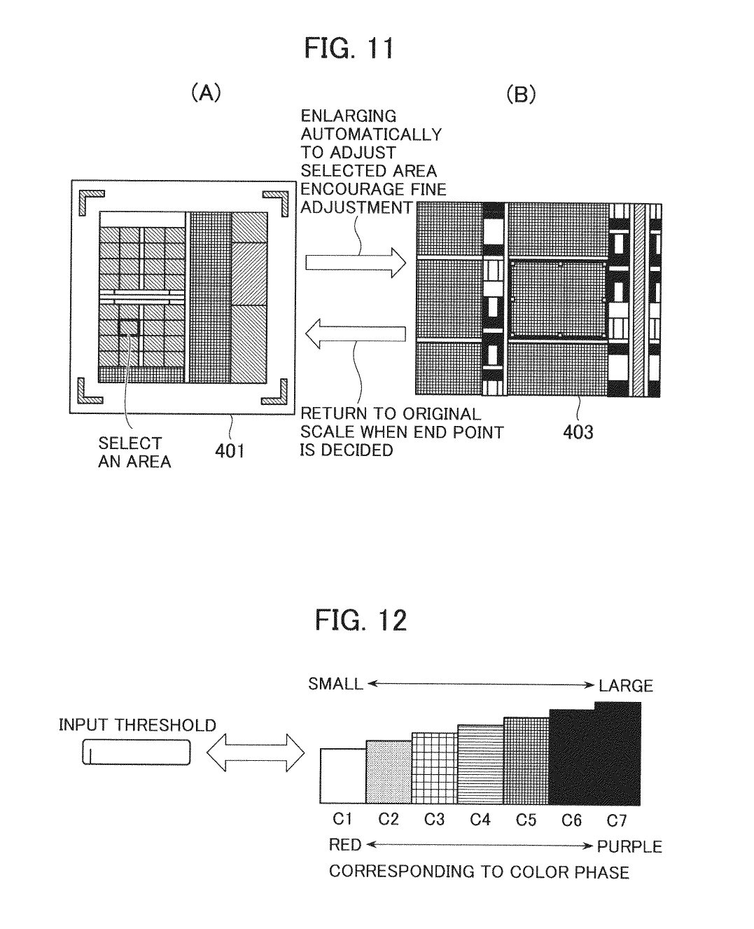

FIG. 11 is a drawing for explaining a function for adjusting a reduced scale of an image to be displayed in accordance with the contents of the work. The timings for changing the reduced scales of the images, such as the enlargement image in the step 303 and the reduction image in the step 308 in FIG. 3, to be displayed were decided. Therefore, the enlarged area 403 ((B) of FIG. 11) is automatically displayed in accordance with the size of the set area ((A) of FIG. 11) at the step 302. Further, the image is automatically returned to the original reduced scale image 401 at the time of the finish of the process in the end point decision step 307 in FIG. 3 (the step 308).

The operations of the steps 302 to 308 are executed by the area setting section 120A in accordance with the operation commands from the operation section 125 and the displayed contents of the display 122.

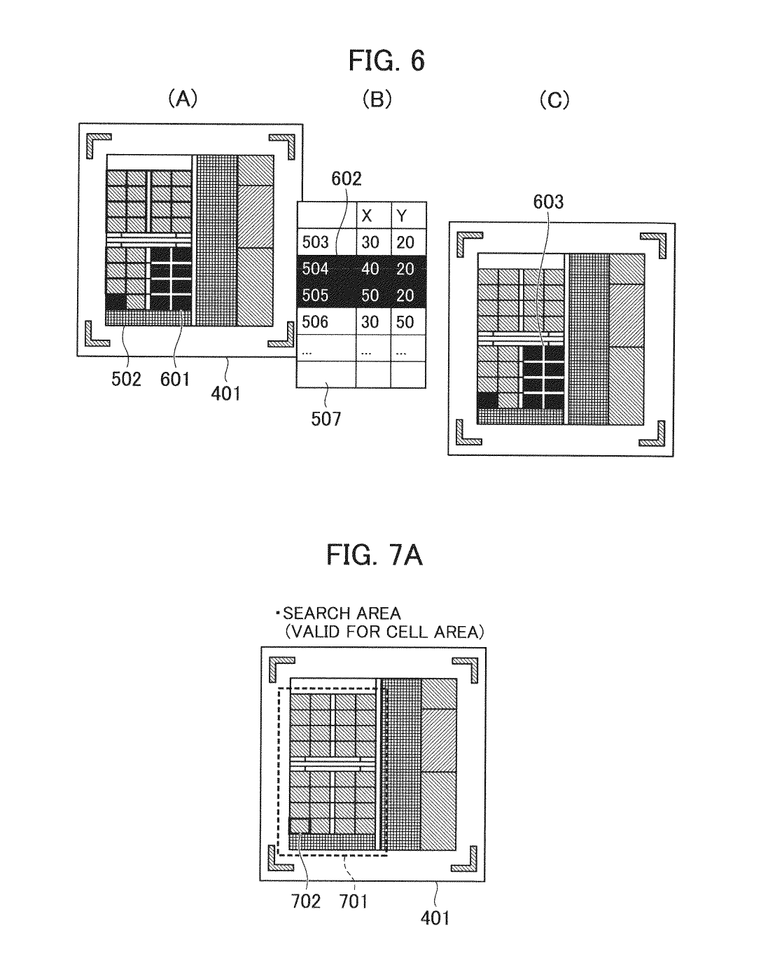

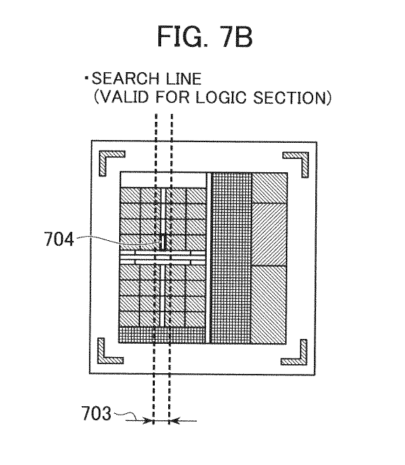

FIG. 5, FIG. 7A, and FIG. 7B are drawings for explaining the operations of searching the similar inspection area in the die, FIG. 6 being a drawing for explaining the operation for sorting and selecting the searched inspection areas in the die. The step 309 in FIG. 3 will be described with reference to FIG. 5 to FIG. 7A, and FIG. 7B.

In (A) of FIG. 5, the similar area searching button 1005 is depressed in condition that the area 501 to be searched in the die. Then, the pattern marching operation is executed by using the search object area 501 as a template. As shown in (B) of FIG. 5, the area 502 is highlighted as a similar area, the area 502 having similar surface shape pattern.

However, it can be supposed that numerous times are required to process the matching operation for the panorama composition image 401 of the whole die which is broad. Therefore, the present invention uses the method for searching a limited range.

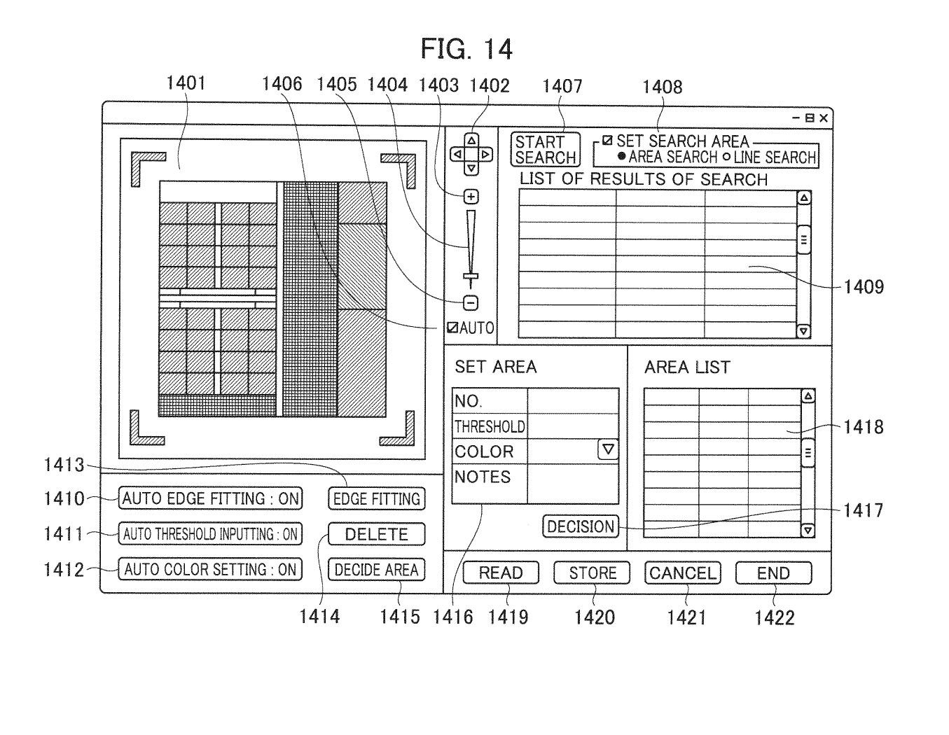

FIG. 7A and FIG. 7B are drawings for explaining a method for setting a searching area at the step 309 for searching an inspection area in the similar die. Further, FIG. 14 is a drawing for showing an example of operation screen to be displayed on the display 122. The method for searching to the limited rage will be explained with reference to FIG. 7 and FIG. 14.

There is the tendency of the cell area sections that gather in a constant range. When a cell area such as the area 702 shown in FIG. 7A is set to be a searching object area, the search range setting (area search) button 1408 shown in FIG. 14 is depressed, thereafter, the searching area of the rectangular area shown by the dotted line 701 is set by using the drag-and drop operations.

Thereafter, the similar area searching button 1005 as shown in FIG. 5 is depressed to execute the matching operation. The operation flow is executed as described above.

When an object area to be searched is a logic section as shown in FIG. 7B, the operations will be explained herein after.

There is the tendency of the logic sections that exist to form a line in a constant direction. When a logic section such as the area 704 shown in FIG. 7B is set to be a searching object area, the search range setting (line search) button 1408 is depressed, thereafter, the directions such as vertical direction and horizontal direction and the width of the search area such as the width 703 are set by the mouse click operations.

Thereafter, the similar area searching button 1005 is depressed to execute the matching operation. The operation flow is executed as described above.

According to the result of the matching operations, as shown in (B) of FIG. 5, the similar area 502 is highlighted and the list 507 of the similar areas is displayed at the same time. This similar area list 507 is a list showing the area number and the XY coordinates of the areas. Candidates for searching (areas 503 to 506) are displayed in order starting with most high degree of similarity in the similar area list 507.

Thereafter, an area can be further selected in the similar areas 502 by executing drag operation in the image again (the similar area 601 in (A) of FIG. 6). The selected similar area 601 is highlighted by a color different from the color of the similar area 502. Further, as shown in (B) of FIG. 6, the similar area list 507 is synchronized with the similar area 601, the area selected from the similar area 601, such as the portion 602, is highlighted.

Thereafter, the decision button 1417 is depressed, so that the selected similar areas only are remained as decided selected areas 603 ((C) of FIG. 6). On the contrary, the selected search candidate 601 only can be deleted from the search candidates by depressing the delete button 1414.

The operation of the step 309 is executed by the similar area setting section 120B.

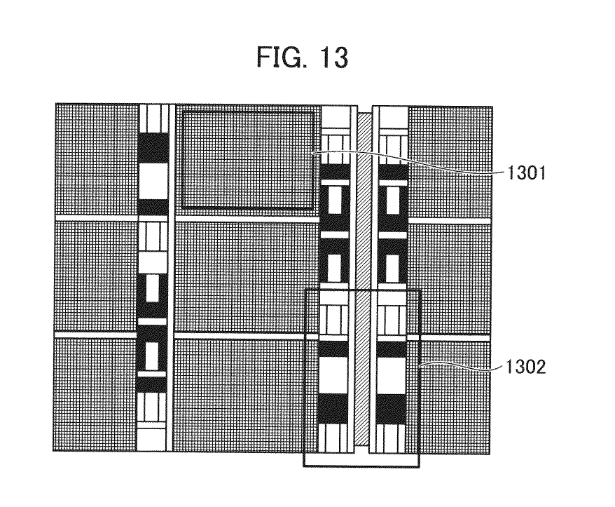

FIG. 13 is a drawing for explaining a function for estimating the sensitivity threshold information based on the image information of the inspection area in the set die, the function corresponding to the process of the step 310 in FIG. 3. One of the reasons for subdividing the area and to set the threshold for each of the subdivided areas is that the area having high contrast of the image such as the logic portion 1302 has the tendency of misjudging the existence of defect that is not presence actually in comparison with the area having low contrast of the image such as the cell area portion 1301.

This is the reason that an error (quantization error) occurred between the pixels in the area having high contrast becomes obvious relatively when the difference between two images is calculated.

Accordingly, the system automatically sets the value as initial value corresponding to the contrast (for example, the value of a (dispersion of brightness of the image) of the light and shade level of each picture element) of the image in the area. Further, the value set as the initial value is displayed in the screen (the threshold display section shown in FIG. 14), and an operator can change the initial value. If the initial value set in the screen is good for the threshold of the sensitivity, the changing operation is not required.

FIG. 12 is a drawing for showing an example for distributing colors to the inspection areas in the set die to be displayed based on the threshold of the sensitivity to be set, corresponding to the process of the step 311 in FIG. 3.

In case of the example shown in FIG. 12, 7 colors of red to purple (C1 to C7) are set, and the threshold value becomes large value from small value as it becomes to C7 from C1. As described above, the color to be displayed is set in order to distinguish the threshold value of the sensitivity of the set area. The color of the color phase corresponding to the threshold value is automatically displayed, so that a mistake of the set value input operation, a data jump or the like can be actualized by using colors.

The processes in the steps 310 and 311 are executed by the threshold setting section 120C.

The setting operations of one group are completed by the above-mentioned processes. If other area is to be set, process is returned to the step 302, the processes in the steps 302 to 311 are executed.

Further, when the setting operations of all inspection areas in the die are completed, the setting results are stored in the memory 124 by the store processing section 120D, the area setting file being transferred to the inspection section 126. The inspection section 126 inspects the object to be inspected by using the area setting file transferred from the memory 124. The above-mentioned operations are the series of the flow of the inspection.

FIG. 14 is a drawing showing one example of the operation screen displayed on the display 122. In FIG. 14, the automatic edge fitting button 1410, the threshold value automatic inputting button 1411, the color automatic setting button 1412, the edge fitting button 1413, the Delete button 1414, and the area setting button 1415 are displayed on the lower side of the panorama image display area 1401.

Further, there are the up down right and left moving button 1402, the enlarging and reducing buttons 1403 to 1405, the automatic button 1406, the search start button 1407, the search area setting button 1408, the search result display area 1409, the area setting area 1416, the decision button 1417, the area list, area 1418, the reading button 1419, the storing button 1420, the cancel button 1421, and the end button 1422.

The works for subdividing the area of the inspection object can be executed at each set threshold value by using the operation screen shown in FIG. 14.

As described above, one embodiment of the present invention can realize a wafer appearance inspection system and a sensitivity threshold setting method for subdividing the area of the inspection object, and capable for executing the works setting the threshold value of the sensitivity at each area easily, and capable for improving the efficiency of the inspection.

Accordingly, a part of the operations of the wafer appearance inspection system is automated and simplified, so that the number of man-hour of iterative process by people's help, and workload can be reduced.

### DESCRIPTION OF REFERENCE NUMERALS

101 - - - Wafer, 102 - - - XYθ stage, 103 - - - Laser optical system, 104 - - - Reflecting mirror, 105 - - - Laser equipment, 106 - - - Laser light, 107 - - - Detect optical system a, 108 - - - Image forming lens a, 109 - - - Area sensor a, 110 - - - AD convertor a, 111 - - - Image processing section a, 112 - - - Detect optical system b, 113 - - - Image forming lens b, 114 - - - Area sensor b, 115 - - - AD convertor b, 116 - - - Image processing section b, 117 - - - Review optical system, 118 - - - Monitoring camera, 119 - - - Image capture section, 120 - - - CPU, 121 - - - Stage control section, 122 - - - Display, 123 - - - Image server, 124 - - - Memory, 125 - - - Operating section, 126 - - - inspection section, 201 - - - Light source, 202 - - - Condensing lens, 203 - - - Aperture, 204 - - - Field diaphragm, 205 - - - Relay lens, 206 - - - Beam splitter, 207 - - - Objective lens, 208 - - - Image forming lens, 401 - - - Panorama composition image, 402 - - - Cell area portion, 403 - - - Enlarged area, 404 - - - Start point handler, 405 - - - End point handler, 406 - - - Logic portion, 407 - - - Area in die, 501 - - - Search object area, 502 - - - Similar area highlighted, 503 - - - Similar area 1, 504 - - - Similar area 2, 505 - - - Similar area 3, 506 - - - Similar area 4, 507 - - - Similar area list, 601 - - - Select similar area highlighted, 602 - - - Area corresponding to 601 in the list, 603 - - - Decided selected area highlighted, 701 - - - Search area (area selection type), 702 - - - Cell area selection highlight, 703 - - - Search area (line selection type), 704 - - - logic section selection highlight, 801 - - - Area to be selected, 802 - - - Edge extraction image, 803 - - - Selected area, 901 - - - Candidate selected corner highlight, 902 - - - No amendment selection highlight, 903 - - - Amended selection highlight, 1001 - - - Edge fitting button, 1002 - - - Selection highlight before processed, 1003 - - - Extracted edge, 1004 - - - Selection highlight after processed, 1301 - - - Cell area portion, 1302 - - - Logic portion

1. A wafer appearance inspection system comprising:
a light irradiation section for irradiating light to a wafer;
a detection section for detecting a light reflected from the wafer;
an image processing section for converting the light detected by the detecting section into an image;
an image display section;
an operating section for inputting operation command;
an operation control section for deciding an image area commanded by the operating section, and for searching an image area different from the image area decided by the operating section to find an image area having a surface shape pattern similar to a surface shape pattern of the image area decided by the control section, and for displaying a found image on the image display section, and for setting a sensitivity threshold value of the image area selected in accordance with a command from the operating section; and
an inspection section for inspecting appearance of the wafer based on the sensitivity threshold value set by the operation control section.

2. The wafer appearance inspection system according to claim 1, wherein
the operation control section arranges numbers of image areas and coordinates of image areas having surface shape pattern similar to the surface shape pattern of the image area decided by the control section in order starting with most high degree of similarity to display on the image display section.

3. The wafer appearance inspection system according to claim 2, wherein
the operation control section highlights the image area having surface shape pattern similar to the surface shape pattern of the image area decided by the control section in order to distinguish from other image areas, displaying highlighting image area on the image display section.

4. The wafer appearance inspection system according to claim 1, wherein
the operation control section displays the image areas with a display color decided for each set sensitivity threshold value on the image display section.

5. The wafer appearance inspection system according to claim 1, further comprising:
a memory for storing the sensitivity threshold value set by the operation control section for each image area,
wherein
the operation control section comprises an area setting section for deciding the image area commanded by the operating section, a similar area setting section for searching and setting image areas having a surface shape pattern similar to a surface shape pattern of the image area decided by the area setting section, a threshold setting section for setting sensitivity threshold values in accordance with commands from the operating section, and a store processing section for storing each of the sensitivity threshold values by the threshold setting section for each of the image areas.

6. A method of setting sensitivity threshold in a wafer appearance inspection system, comprising the steps of:
irradiating a light to a wafer, and detecting a light reflected from the wafer, and displaying an image of the light reflected from the wafer on an image display section, and deciding an image area commanded by the operating section for inputting operation command;
searching an image area different from the image area decided by the operating section to find an image area having a surface shape pattern similar to a surface shape pattern of the image area decided by the control section, and displaying a found image on the image display section; and
setting a sensitivity threshold value of the image area selected in accordance with a command from the operating section.

7. The method of setting sensitivity threshold in a wafer appearance inspection system according to claim 6, wherein
Arranging numbers of image areas and coordinates of image areas having surface shape pattern similar to the surface shape pattern of the image area decided by the control section in order starting with most high degree of similarity to display on the image display section.

8. The method of setting sensitivity threshold in a wafer appearance inspection system according to claim 7, wherein
highlighting the image area having surface shape pattern similar to the surface shape pattern of the image area decided by the control section in order to distinguish from other image areas, displaying highlighting image area on the image display section.

9. The method of setting sensitivity threshold in a wafer appearance inspection system according to claim 6, wherein
displaying the image areas with a display color decided for each set sensitivity threshold value on the image display section.
